(19) United States
(12) Patent Application Publication
(10) Pub. No.: US 2025/0027634 A1
(43) Pub. Date: Jan. 23, 2025

(54) LIGHT BRANCH SEPARATION REGULATOR, LIGHT BUNDLE AND LIGHT WITH SAME

(71) Applicant: HANGZHOU JINYIJIA E-COMMERCE CO., LTD., Hangzhou (CN)

(72) Inventor: Xudong ZHOU, Hangzhou (CN)

(21) Appl. No.: 18/522,893

(22) Filed: Nov. 29, 2023

(30) Foreign Application Priority Data
Jul. 20, 2023 (CN) 202321917701.2

(51) Int. Cl. F21V 17/08; F21V 21/108

(52) U.S. Cl. CPC F21V 17/08; F21V 21/108; F21Y 2101/00; F21Y 2107/70; F21Y 2113/00

(57) ABSTRACT

The present invention provides a light branch separation regulator, a light and a light bundle with the light branch separation regulator. The light branch separation regulator includes a tapered tube and a limiting part. The tapered tube has a tapered surface. The limiting part includes at least two limiting pieces, and the at least two limiting pieces are disposed around the tapered tube. When the light branch separation regulator cooperates with the light bundle, the tapered tube separates at least two light branches of the light bundle, and the at least two limiting pieces limit the at least two light branches on the tapered surface. In actual use, two or more light branches are kept spreading by the tapered surface. Moreover, the light branches can still sway to a certain extent under the action of external forces, thereby having the advantages of simple assembly and good lighting effect.

### CROSS-REFERENCE TO RELATED APPLICATIONS

This application claims priority to Chinese Patent Application No. 202321917701.2 filed on Jul. 20, 2023, the entire contents of which are incorporated herein by reference.

### BACKGROUND OF THE INVENTION

### Field of the Invention

The present invention relates to a decorative light technology, in particular to a light branch separation regulator, and a light bundle and light with the light branch separation regulator.

### Description of the Related Art

A light bundle is named for its shape like a bouquet, with a number of light branches, and its overall shape is a bundle-like light, which plays a decorative role. In practical applications, when the light bundle is mounted in the grass or the forest, a plurality of light branches may sway with the wind, and light emitted by the light bundle also sways in the air with the wind. Moreover, the light may become far or near and flickering, as if fireflies flying in the air, thus meeting requirements of people for aesthetic designs of lights.

During actual installation and layout of the light, in order to separate light branches of the existing light bundle, it is necessary to manually separate the light branches of the light bundle one by one. Steel wires are embedded in the light branches, and the light branches are shaped by the steel wires. If the steel wires are too soft, the light branches may not be shaped. If the steel wires are too hard, each light branch is difficult to shape. In particular, if the light branches are separated with hands, the steel wires inside actually appear as broken lines, and it is difficult for the single light branches to show smooth arcs. The plurality of light branches of the whole light bundle may not be evenly dispersed. During overall layout of the light, attractive modeling is difficult to form without strong sense of beauty and practical ability. In addition, after long-term use of the existing light bundle, due to the heavy weight of a light bulb at the top, the light branches slowly become more and more curved and may not maintain an original shape. In particular, the steel wires may not be completely restored after being bent, and the light bundle may neither restore to the original bundle shape nor be arbitrarily changed into other shapes.

### BRIEF SUMMARY OF THE INVENTION

In order to overcome the defects and existing problems in the prior art, the present invention provides a light branch separation regulator, and a light bundle and light with the light branch separation regulator.

In one aspect, the present invention provides a light branch separation regulator. The light branch separation regulator includes a tapered tube and a limiting part. The tapered tube has a tapered surface. The limiting part includes at least two limiting pieces, and the at least two limiting pieces are disposed around the tapered tube. When the light branch separation regulator is used in conjunction with a light bundle, the tapered tube separates at least two light branches of the light bundle, and the at least two limiting pieces limit the at least two light branches on the tapered surface.

Optionally, the light branch separation regulator is slidably disposed on the light bundle to regulate a degree of dispersion and spreading of the at least two light branches.

Optionally, the tapered tube further has a mounting tube, and the limiting part is disposed on the mounting tube.

Optionally, each of the limiting pieces has a notch and removably clamps a corresponding light branch.

Optionally, a cross section of each of the limiting pieces is a ring, and each of the limiting pieces is disposed on a corresponding light branch in a sleeving manner.

Optionally, the limiting part includes a first limiting part and a second limiting part, and the first limiting part and the second limiting part are located at two ends of the tapered tube respectively.

Optionally, each of the limiting pieces has a notch and removably clamps a corresponding light branch, and an orientation of the notches of the limiting pieces of the first limiting part is inconsistent with that of the notches of the limiting pieces of the second limiting part.

Optionally, a cross section of the tapered tube is any one of a circle, an oval, a heart, or a polygon.

In another aspect, the present invention further provides a light bundle. The light bundle includes at least two light branches, at least two light beads, and any one of the light branch separation regulators described above. Each of the light beads is disposed at one end of a corresponding light branch. The tapered tube separates the at least two light branches of the light bundle, and the at least two limiting pieces limit the at least two light branches on the tapered surface.

In another aspect, the present invention further provides a light. The light includes at least two light branches, at least two light beads, any one of the light branch separation regulators described above, and a power supply. Each of the light beads is disposed at one end of a corresponding light branch. The tapered tube separates the at least two light branches of the light bundle, and the at least two limiting pieces limit the at least two light branches on the tapered surface. The power supply is electrically connected to the at least two light beads through the at least two light branches.

In the light branch separation regulator according to the present invention, the at least two light branches are limited on the tapered surface through the limiting part, and the at least two light branches are dispersed under the separation action of the two tapered tube. Considering characteristics of the structure of the light branches, the light branches may tilt after being spread, the tapered surface with a conical degree is fitted with the tilting light branches, and the tapered surface with the conical degree may well abut against the tilting light branches, so that the at least two light branches may be stably kept in a spreading state. In addition, as the tapered tube only keeps the at least two light branches spread, the light branches may still sway to a certain extent under external forces such as wind and impact, and produce a far or near light spot effect in practical use. Therefore, the light branch separation regulator according to the present invention has the advantages of simple assembly, good limiting effect and good lighting effect. In particular, the at least two light branches may be evenly dispersed on the tapered surface. When the at least two light branches are spread, elastic forces generated by bending of the light branches may be offset mutually, so that the problem that a part of the light branches are bent but the other part of the light branches are not bent is avoided, all the light branches may be bent by a basically consistent degree, and height positions of the light beads on all the light branches are basically consistent. The modeling of the light bundle may not change even after long-term use.

### BRIEF DESCRIPTION OF THE DRAWINGS

FIG. 1 is a schematic three-dimensional diagram of a light branch separation regulator according to a first embodiment of the present invention;

FIG. 2 is a schematic top view of a light branch separation regulator according to a first embodiment of the present invention;

FIG. 3 is a schematic cross-sectional diagram of a light branch separation regulator according to a first embodiment of the present invention;

FIG. 4 is a schematic three-dimensional diagram of a light branch separation regulator according to a second embodiment of the present invention;

FIG. 5 is a schematic cross-sectional diagram of a light branch separation regulator according to a second embodiment of the present invention;

FIG. 6 is a schematic three-dimensional diagram of a light branch separation regulator according to a third embodiment of the present invention;

FIG. 7 is a schematic cross-sectional diagram of a light branch separation regulator according to a third embodiment of the present invention;

FIG. 8 is a schematic diagram of a light bundle and a light according to an embodiment of the present invention; and

FIG. 9 is a schematic enlarged view of a position “A” in FIG. 8 according to the present invention.

### DETAILED DESCRIPTION OF THE INVENTION

In order to facilitate the understanding of a person skilled in the art, the present invention is further described below in connection with the accompanying drawings and specific embodiments.

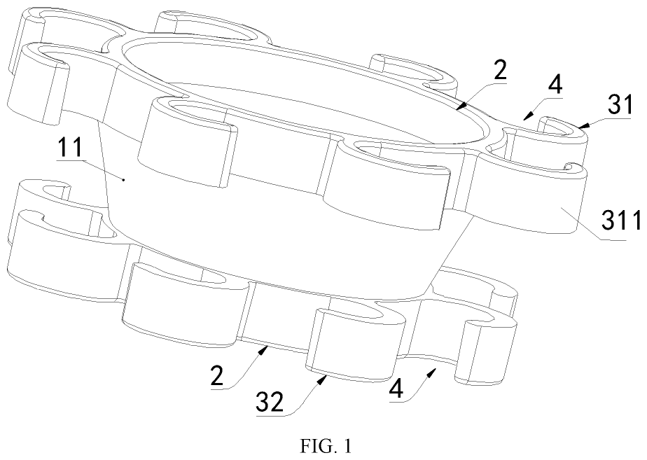

As shown in FIG. 1 to FIG. 3 and FIG. 8, a first embodiment of the present invention provides a light branch separation regulator, and a light bundle and light with the light branch separation regulator. The light branch separation regulator includes a tapered tube 1 and limiting parts 3.

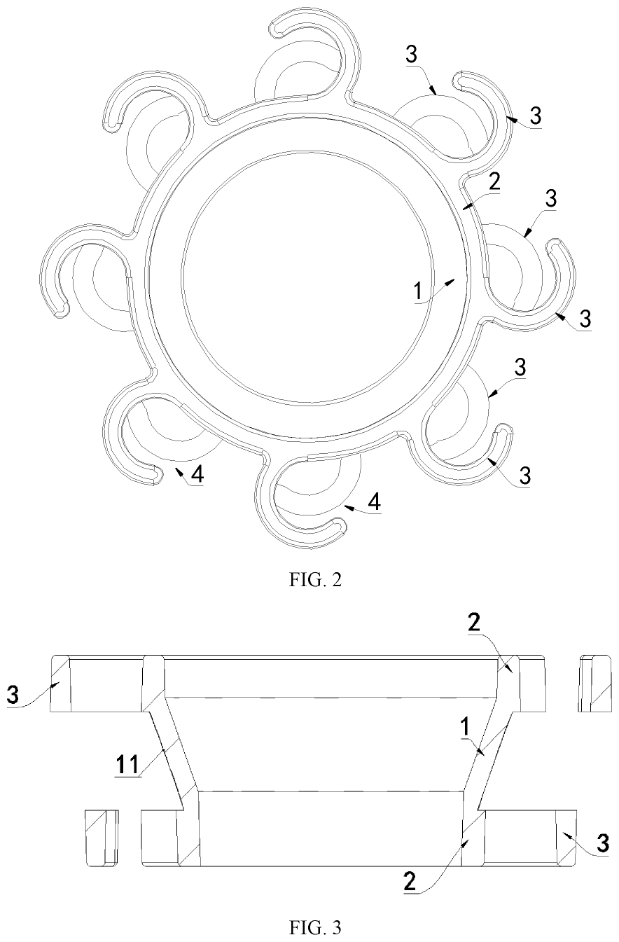

The tapered tube 1 has a tapered surface 11, and the tapered surface 11 is an outer side face of the tapered tube 1. Specifically, when the light branch separation regulator is placed horizontally as shown in FIG. 3, a longitudinal profile of the tapered surface is a tilt line with an angle (for example, 45 degrees, 60 degrees, and 70 degrees) between 0 and 90 degrees from the horizontal plane. In this embodiment, a longitudinal section of the tapered tube is trapezoidal (that is, when the light branch separation regulator is placed horizontally as shown in FIG. 3, two ends of the tapered tube are two horizontal planes). However, the present invention does not limit this in any way. In other embodiments, the longitudinal section of the tapered tube may be triangular (that is, a lower end of the tapered tube 1 may be a point and an upper end of the tapered tube may be a plane) or irregularly quadrilateral (that is, two end faces of the tapered tube may also be inclined when the light branch separation regulator is placed horizontally). The tapered tube 1 may be a conical tube or a pyramid tube. In this embodiment, a cross section of the tapered tube 1 is circular (as shown in FIG. 2). However, the present invention does not limit this in any way. The cross section of the tapered tube may be a circle, an oval, a heart, or any polygon (such as a triangle, a square, a rectangle, a diamond, a five-pointed star, and an irregular polygon). The cross section of the tapered tube may also be any combination of regular and irregular shapes. By adoption of the different cross section designs, the light bundle may be dispersed to form different patterns.

The two ends of the tapered tube 1 in this embodiment are provided with tube openings, and an inner diameter of the tube opening of one end of the tapered tube 1 is smaller than that of the tube opening of the other end of the tapered tube 1, so that the tapered tube 1 has a conical degree. In this embodiment, the tapered tube 1 is further provided with mounting tubes 2, and the limiting parts are disposed on the mounting tubes 2. A shape of the two mounting tubes 2 matches a shape of the tube openings of the two ends of the tapered tube 1. The mounting tubes 2 are outward extending portions of the corresponding tube openings of the tapered tube 1. By providing the mounting tubes 2 without the conical degree, the light branch separation regulator may be prevented from sliding along a length direction of the light branches without external forces to a certain extent. However, the present invention does not limit this in any way. In other embodiments, the tapered tube may not be provided with the mounting tubes, and the limiting parts are directly fixed to the tapered surface of the tapered tube.

Each of the limiting parts 3 includes at least two limiting pieces 311. The at least two limiting pieces 311 are disposed around the tapered tube 1. In this embodiment, the limiting parts 3 include a first limiting part 31 and a second limiting part 32. The first limiting part 31 and the second limiting part 32 are located at the two ends of the tapered tube 1 respectively. Specifically, the first limiting part and the second limiting part are disposed on outer side faces of the two mounting tubes 2 respectively.

In this embodiment, the first limiting part 31 includes eight limiting pieces, the second limiting part 32 also includes eight limiting pieces, and the total quantity of the limiting pieces 311 is sixteen. The limiting pieces of this embodiment are evenly arranged around the tapered tube, so that the light bundle is dispersed more evenly. However, the present invention does not limit this in any way. In other embodiments, the limiting pieces may not be evenly arranged or the quantity thereof is reduced for modeling needs. In practical use, the quantity of the limiting pieces 311 is not smaller than the quantity of the light branches 5. The at least two light branches 5 may be mounted on the different limiting pieces 311 respectively, so that the light branches 5 are mounted on the light branch separation regulator one by one.

In this embodiment, each of the limiting pieces 311 has a notch 4 and removably clamps a corresponding light branch 5. Specifically, a cross section of each of the limiting pieces 311 is arc, and the notches 4 are provided in side faces of the limiting pieces 311. In practical use, a user may mount the light branches 5 to the limiting pieces 311 or remove the light branches from the limiting pieces 311 via the notches 4. A width of the notches 4 is smaller than a diameter of the light branches 5. The light branches 5 may be elastically deformed when passing through the notches 4, to avoid the light branches 5 from accidentally falling off the limiting pieces 311 via the notches 4.

In this embodiment, an orientation of the notches of the limiting pieces of the first limiting part is inconsistent with that of the notches of the limiting pieces of the second limiting part. Specifically, as seen from a direction of FIG. 2, the limiting pieces of the first limiting part 31 are bent in a counterclockwise direction and are open at tail ends, and the limiting pieces of the second limiting part 32 are bent in a clockwise direction and are open at tail ends. In this way, the same light branch 5 may be fixed within two limiting pieces 311 up and down with the notches of inconsistent orientations, to avoid the light branch 5 from accidentally falling off the limiting pieces 311 via the notches. Thus, the light branches 5 may be better limited. In this embodiment, the quantity of the limiting pieces 311 is not smaller than twice the quantity of the light branches 5.

The light branch separation regulator according to this embodiment is a thin-walled part, and the tapered tube 1, the mounting tubes 2 and the limiting parts 3 are integrally formed, so that the manufacturing cost of the light branch separation regulator is greatly reduced.

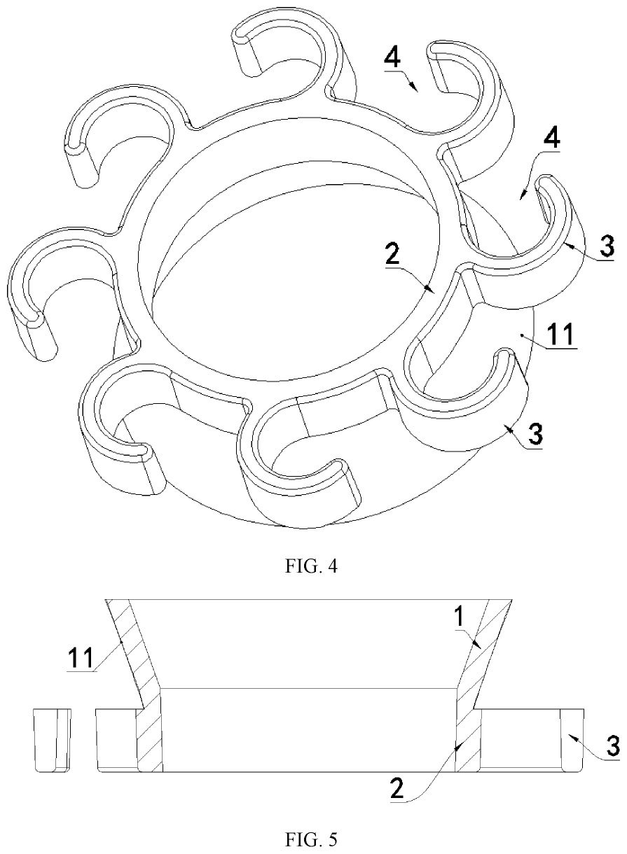

FIG. 4 to FIG. 5 are schematic diagrams of a light branch separation regulator according to a second embodiment of the present invention. The difference between the light branch separation regulator according to the second embodiment and the light branch separation regulator according to the first embodiment is that only one limiting part is provided, correspondingly, only one mounting tube is provided, and other components have the same structure and function, which will not be repeated herein.

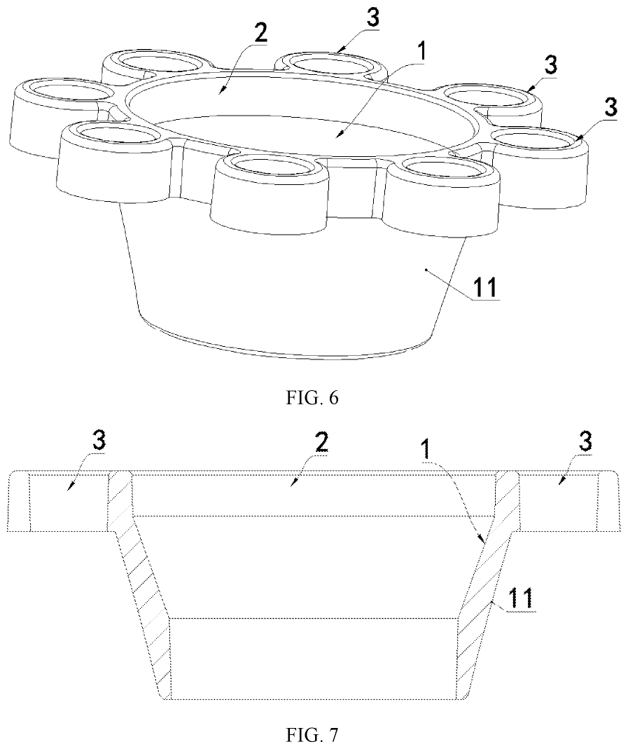

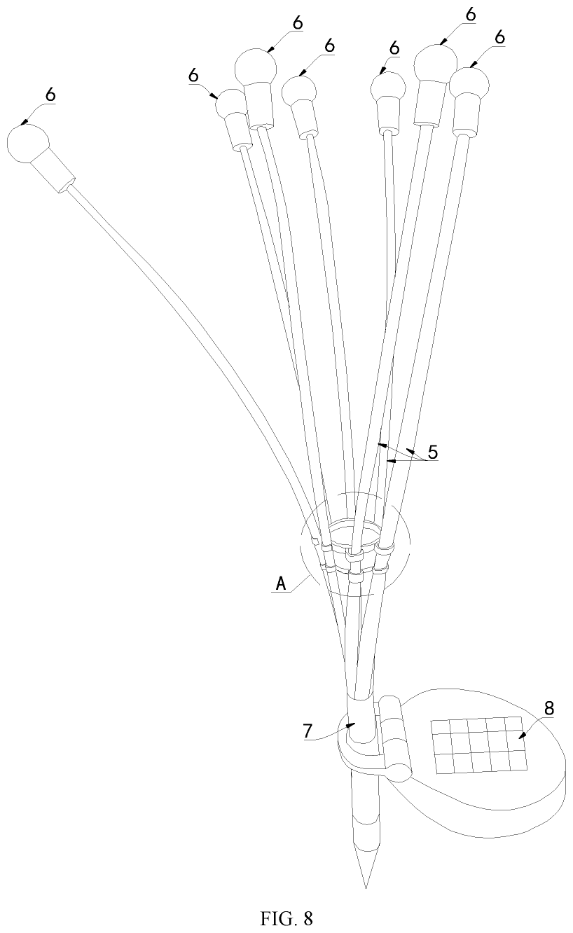

FIG. 6 to FIG. 7 are schematic diagrams of a light branch separation regulator according to a third embodiment of the present invention. The difference between the light branch separation regulator according to the third embodiment and the light branch separation regulator according to the first embodiment is that only one limiting part is provided, correspondingly, only one mounting tube is provided, and the limiting pieces have circular cross sections and have no notch. In this way, the light branches may be directly sleeved with rings of the limiting pieces, and the degree of dispersion and spreading of the light branches may be adjusted only by sliding the light branch separation regulator to adjust a position of the light branch separation regulator on the light branches. Thus, an action of additionally fixing the light branches and each limiting piece during use of the light is omitted.

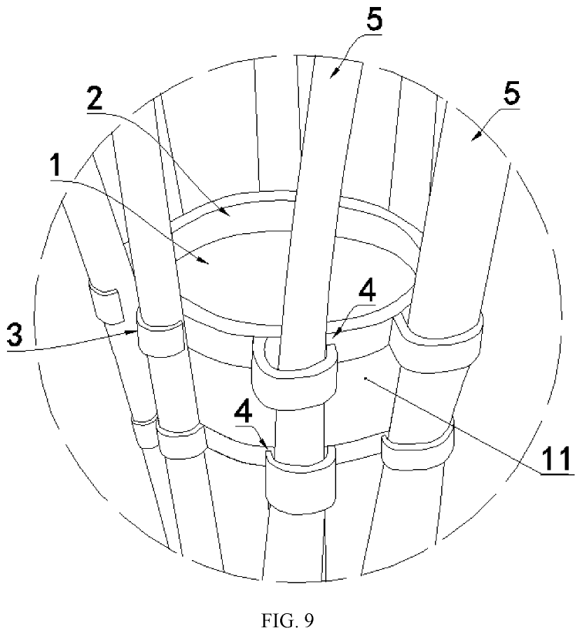

As shown in FIG. 8 to FIG. 9, the present invention further provides a light bundle and a light. The light bundle includes a plurality of light branches 5, and the light branches 5 may be elastically deformed. Each of the light branches 5 is provided with a light bead 6. In this embodiment, the light beads 6 are spherical, but the present invention does not limit a shape of the light beads 6 in any way. In other embodiments, the light beads 6 may have flower modeling, hot air balloon modeling, etc.

The quantity of the light branches 5 is at least two. On ends of the two or more light branches 5 are fixed together. The at least two light branches 5 are in a bundle shape. In this embodiment, the light bundle includes a sleeve 7, and one ends of the at least two light branches 5 are inserted in the sleeve 7, so that one ends of the at least two light branches 5 are bound together, and the other ends of the at least two light branches may be dispersed, thereby allowing the whole light bundle to be in a bundle shape. The light beads 6 and the sleeve 7 are disposed at two ends of the light branches 5 respectively. The light further includes a power supply 8, and the power supply 8 is electrically connected to the at least two light beads 6 through the at least two light branches 5.

When the light branch separation regulator is used in conjunction with the light bundle, the tapered tube separates the at least two light branches 5 of the light bundle, and the at least two limiting pieces 311 limit the at least two light branches 5 on the tapered surface 11. In practical use, if the light branches 5 are spread, the light branches may be bent to a certain extent, resulting in tilting of the light branches 5. Thus, when the light branches 5 are separated by using the tapered tube 1 with the conical degree, the tapered surface 11 firmly abuts against the spread light branches 5 to keep a dispersed state of the light branches 5. Meanwhile, the light branches 5 also provide a certain supporting force for the tapered tube to limit the position of the light branch separation regulator, and the light branches and the tapered tube achieve a balance without external forces.

In particular, when the at least two light branches 5 are spread, elastic forces generated by bending of the light branches may be offset mutually, so that the problem that a part of the light branches 5 are bent but the other part of the light branches 5 are not bent is avoided, all the light branches 5 may be bent by a basically consistent degree, and height positions of the light beads 6 on all the light branches 5 are basically consistent.

In addition, as the tapered tube 1 only keeps the at least two light branches 5 spread, the light branches 5 may still sway to a certain extent under external forces such as wind and impact, and may produce a flickering and far or near light spot effect in practical use in conjunction with a power supply control element. Therefore, the light branch separation regulator has the advantages of simple assembly, good limiting effect and good lighting effect.

By adopting tapered surfaces 11 with different conical degrees and outlines, an arrangement structure of the at least two light branches 5 after spreading may be changed, and a light spot effect of different arrangements may be produced in practical use. Therefore, on the premise of maintaining the conical degree of the tapered surface 11, by designing the tapered tube 1 to have different conical degrees and outlines, the light spot effect of different arrangements may be achieved for users, and the requirements of the users for aesthetic designs of decorative lights are better met.

In this embodiment, the light branches 5 are removably disposed on the limiting part 3, so that the at least two light branches 5 are limited on the tapered surface 11. The removable structure between the light branches 5 and the limiting part 3 includes, but is not limited to, at least one of a magnetic attraction structure, a clamped structure, and an inserted structure.

In practical use, the limiting pieces 311 may clamp any position of the light branches 5 in the length direction. The spreading size of the at least two light branches 5 may be adjusted by adjusting positions of the limiting pieces 311 on the light branches 5 in the length direction. In this embodiment, the light branch separation regulator is slidably disposed on the light bundle, and the spreading degree of the light bundle may be adjusted only by sliding the light branch separation regulator along the length direction of the light branches 5 (as shown in FIG. 8, the light branch separation regulator may slide up and down). If the light branches 5 need to be evenly dispersed, the light branch separation regulator slides towards the fixed ends of the light branches (a lower portion as shown in FIG. 8). If the light branches 5 need to be gathered to reduce the degree of bending and spreading thereof, the light branch separation regulator slides towards unconstrained ends of the light branches (an upper portion as shown in FIG. 8). In the light bundle and light with the light branch separation regulator according to the present invention, the degree of dispersion and bending of the light branches thereof may be easily adjusted so as to adjust the modeling of the light bundle, and the defects that adjustment is difficult and laborious, and light branches may not be evenly dispersed or may not restore after spreading in the prior art are overcome.

In this embodiment, a cross-sectional area of a space defined by each of the limiting pieces 311 may be slightly greater than a cross-sectional area of the corresponding light branch 5, so that the light branch separation regulator may slide freely along the length direction of the light branches 5. However, the present invention does not limit this in any way. In other embodiments, the limiting pieces 311 may be in interference fit with the light branches 5. In this case, the light branch separation regulator may be fixed on the light branches 5, and if the position of the light branch separation regulator needs to be adjusted, the light branches 5 need to be removed from the limiting pieces 311 and then fixed and limited at other positions.

The above embodiments are merely preferred embodiments of the present invention, and are not intended to limit the scope of protection of the present invention. Therefore, any equivalent changes made in accordance with the structure, shape, and principles of the present invention shall fall within the scope of protection of the present invention.

1. A light branch separation regulator, comprising:
a tapered tube, having a tapered surface; and
a limiting part, comprising at least two limiting pieces, the at least two limiting pieces being disposed around the tapered tube,
wherein when the light branch separation regulator is used in conjunction with a light bundle, the tapered tube separates at least two light branches of the light bundle, and the at least two limiting pieces limit the at least two light branches on the tapered surface.

2. The light branch separation regulator according to claim 1, wherein the light branch separation regulator is slidably disposed on the light bundle to regulate a degree of dispersion and spreading of the at least two light branches.

3. The light branch separation regulator according to claim 1, wherein the tapered tube further has a mounting tube, and the limiting part is disposed on the mounting tube.

4. The light branch separation regulator according to claim 1, wherein each of the limiting pieces has a notch and removably clamps a corresponding light branch.

5. The light branch separation regulator according to claim 1, wherein a cross section of each of the limiting pieces is a ring, and each of the limiting pieces is disposed on a corresponding light branch in a sleeving manner.

6. The light branch separation regulator according to claim 1, wherein the limiting part comprises a first limiting part and a second limiting part, and the first limiting part and the second limiting part are located at two ends of the tapered tube respectively.

7. The light branch separation regulator according to claim 6, wherein each of the limiting pieces has a notch and removably clamps a corresponding light branch, and an orientation of the notches of the limiting pieces of the first limiting part is inconsistent with that of the notches of the limiting pieces of the second limiting part.

8. The light branch separation regulator according to claim 1, wherein a cross section of the tapered tube is any one of a circle, an oval, a heart, or a polygon.

9. A light bundle, comprising:
at least two light branches;
at least two light beads, each of the light beads being disposed at one end of a corresponding light branch; and
the light branch separation regulator as claimed in claim 1, wherein the tapered tube separates the at least two light branches of the light bundle, and the at least two limiting pieces limit the at least two light branches on the tapered surface.

10. A light, comprising:
at least two light branches;
at least two light beads, each of the light beads being disposed at one end of a corresponding light branch;
the light branch separation regulator as claimed in claim 1, wherein the tapered tube separates the at least two light branches of the light bundle, and the at least two limiting pieces limit the at least two light branches on the tapered surface; and
a power supply electrically connected to the at least two light beads through the at least two light branches.
